(19) United States
(12) Patent Application Publication
(10) Pub. No.: US 2013/0141393 A1
(43) Pub. Date: Jun. 6, 2013

(54) FRAMELESS OPTICAL TOUCH DEVICE AND IMAGE PROCESSING METHOD FOR FRAMELESS OPTICAL TOUCH DEVICE

(71) Applicants: Yu-Yen Chen, New Taipei City (TW); Kou-Hsien Lu, New Taipei City (TW); Shang-Chin Su, New Taipei City (TW); Hsun-Hao Chang, New Taipei City (TW)

(72) Inventors: Yu-Yen Chen, New Taipei City (TW); Kou-Hsien Lu, New Taipei City (TW); Shang-Chin Su, New Taipei City (TW); Hsun-Hao Chang, New Taipei City (TW)

(21) Appl. No.: 13/606,033

(22) Filed: Sep. 7, 2012

(30) Foreign Application Priority Data
Dec. 6, 2011 (TW) 100144806

(51) Int. Cl. G06F 3/042

(52) U.S. Cl. 345/175

(57) ABSTRACT

A frameless optical touch device includes an indication plane, an image sensing unit, a light emitting unit and a processing unit. There is no any frame disposed on a periphery of the indication plane such that a first light from an external environment can enter a sensing region defined on the indication plane through the periphery of the indication plane. The light emitting unit emits a second light to the sensing region. When there is no any touch object in the sensing region, the image sensing unit senses the first and second lights to generate a first image. When a touch object is in the sensing region, the image sensing unit senses the first and second lights to generate a second image. The processing unit compares brightness of the first image with brightness of the second image so as to obtain a position blocked by the touch object.

### BACKGROUND OF THE INVENTION

1. Field of the Invention

The invention relates to an optical touch device and, more particularly, to a frameless optical touch device and an image processing method for the frameless optical touch device.

2. Description of the Prior Art

Since consumer electronic products have become more and more lighter, thinner, shorter, and smaller, there is no space on these products for containing a conventional input device, such as mouse, keyboard, etc. With development of touch technology, in various kinds of consumer electronic products (e.g. display device, all-in-one device, mobile phone, personal digital assistant (PDA), etc.), a touch device has become a main tool for data input. Compared with other touch design, such as a resistive touch design, a capacitive touch design, an ultrasonic touch design, or a projective touch design, an optical touch design has lower cost and is easier to use.

A conventional optical touch device senses a position indicated by a touch object (e.g. finger or stylus) on an indication plane by an optical manner. When an image sensing unit senses the touch object within an sensing region defined on the indication plane, a processing unit of the optical touch device can calculate a position indicated by the touch object accordingly. In general, there is always a frame disposed on a periphery of the indication plane so as to isolate noise (e.g. environmental light) outside of the sensing region and generate distinct brightness variation between the touch object (e.g. finger) and background.

Referring to FIGS. 1 and 2, FIG. 1 is a schematic diagram illustrating an optical touch device 1 of the prior art, and FIG. 2 is a schematic diagram illustrating another optical touch device 1′ of the prior art. As shown in FIG. 1, the optical touch device 1 comprises an indication plane 10, two image sensing units 12, two light emitting units 14 and a frame 16. The two image sensing units 12 are disposed at opposite corners of the indication plane 10 respectively. The two light emitting units 14 are disposed adjacent to the two image sensing units 12 respectively. The frame 16 is disposed on a periphery of the indication plane 10. When a touch object 3 (e.g. finger) is in the indication plane 10, a position blocked by the touch object 3 and sensed by the image sensing unit 12 is bright relatively. Then, a processing unit of the optical touch device 1 can determine the position blocked by the touch object 3 on the indication plane 10 according to the relative bright area.

As shown in FIG. 2, the main difference between the optical touch device 1′ and the optical touch device 1 is that a plurality of light emitting units 14 is disposed around the indication plane 10 of the optical touch device 1′ instead of being disposed adjacent to the image sensing units 12. The frame 16 is used for isolating environmental light 2 outside of the sensing region 100 so as to generate distinct brightness variation between the touch object 3 and background. When the touch object 3 (e.g. finger) is in the indication plane 10, a position blocked by the touch object 3 and sensed by the image sensing unit 12 is dark relatively. Then, a processing unit of the optical touch device 1′ can determine the position blocked by the touch object 3 on the indication plane 10 according to the relative dark area.

As mentioned in the above, the frame 16 is necessary for the optical touch devices 1 and 1′ both. In other words, the optical touch devices 1 and 1′ cannot sense touch position without the frame 16. However, the frame 16 will not only cause assembly problem of the optical touch devices 1 and 1′ but also increase manufacture cost of the optical touch devices 1 and 1′. Furthermore, since the electronic products have become more and more lighter, thinner, shorter, and smaller, the edge of non-display area should be as small as possible. If the frame 16 can be removed from the optical touch devices 1 and 1′ without influencing touch detection, the electronic products equipped with the optical touch device 1 or 1′ may get light, assembly of the electronic products may get easy, and manufacture cost of the electronic products may decrease.

### SUMMARY OF THE INVENTION

The invention provides a frameless optical touch device and an image processing method for the frameless optical touch device so as to solve the aforesaid problems.

According to an embodiment of the invention, a frameless optical touch device comprises an indication plane, an image sensing unit, a light emitting unit and a processing unit. A sensing region is defined on the indication plane. There is no any frame disposed on a periphery of the indication plane such that a first light from an external environment is able to enter the sensing region through the periphery of the indication plane. The image sensing unit is disposed at a corner of the indication plane. The light emitting unit is disposed adjacent to the image sensing unit and used for emitting a second light to the sensing region. The processing unit is electrically connected to the image sensing unit and the light emitting unit . When there is no any touch object in the sensing region, the image sensing unit senses the first light and the second light within the sensing region so as to generate a first image. When a touch object is in the sensing region, the image sensing unit senses the first light and the second light within the sensing region so as to generate a second image. The processing unit compares brightness of the first image with brightness of the second image so as to obtain a position blocked by the touch object in the second image.

According to another embodiment of the invention, an image processing method is adapted for a frameless optical touch device. The frameless optical touch device comprises an indication plane, an image sensing unit and a light emitting unit. A sensing region is defined on the indication plane. There is no any frame disposed on a periphery of the indication plane such that a first light from an external environment is able to enter the sensing region through the periphery of the indication plane. The image sensing unit is disposed at a corner of the indication plane. The light emitting unit is disposed adjacent to the image sensing unit and used for emitting a second light to the sensing region. The image processing method comprises steps of controlling the image sensing unit to sense the first light and the second light within the sensing region so as to generate a first image when there is no any touch object in the sensing region; controlling the image sensing unit to sense the first light and the second light within the sensing region so as to generate a second image when a touch object is in the sensing region; and comparing brightness of the first image with brightness of the second image so as to obtain a position blocked by the touch object in the second image.

As mentioned in the above, there is no any frame disposed on the periphery of the indication plane of the frameless optical touch device of the invention such that the first light from an external environment is able to enter the sensing region through the periphery of the indication plane. Before and after the touch object is in the sensing region, the image sensing unit senses both the first light from the external environment and the second light from the light emitting unit so as to generate the first image and the second image. Afterward, the processing unit compares brightness of the first image with brightness of the second image by image processing technology so as to obtain the position blocked by the touch object in the second image. Since the frameless optical touch device of the invention does not have the frame disposed on the periphery of the indication plane of the prior art, the invention can enhance assembly efficiency and reduce manufacture cost of the frameless optical touch device effectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an optical touch device of the prior art.

FIG. 2 is a schematic diagram illustrating another optical touch device of the prior art.

FIG. 3 is a schematic diagram illustrating a frameless optical touch device according to an embodiment of the invention.

FIG. 4 is a diagram illustrating brightness distribution of a first image generated by an image sensing unit while there is no any touch object in a sensing region shown in FIG. 3.

FIG. 5 is a schematic diagram illustrating a touch object in a sensing region shown in FIG. 3.

FIG. 6 is a diagram illustrating brightness distribution of a second image generated by an image sensing unit while there is a touch object in a sensing region shown in FIG. 5.

FIG. 7 is a diagram illustrating brightness variation between brightness distribution of the first image (solid line) shown in FIG. 4 and brightness distribution of the second image (broken line) shown in FIG. 6, wherein a brightness variation area represents the position blocked by the touch object.

FIG. 8 is a diagram illustrating brightness distribution of the brightness variation area shown in FIG. 7.

FIG. 9 is a diagram illustrating brightness distribution of the brightness variation area after being transformed into absolute values.

FIG. 10 is a flowchart illustrating an image processing method for the frameless optical touch device according to an embodiment of the invention.

### DETAILED DESCRIPTION

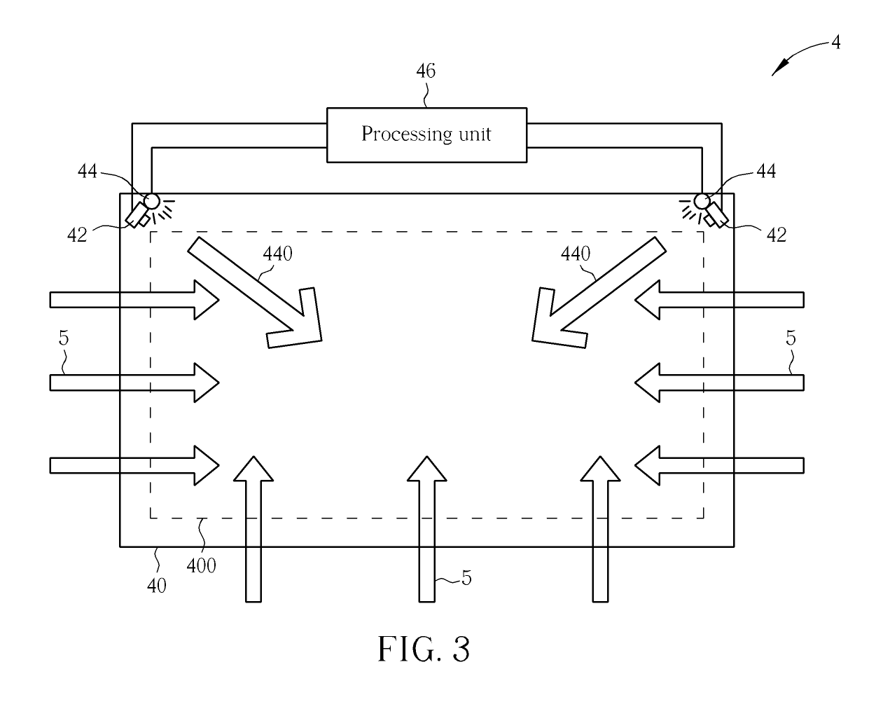

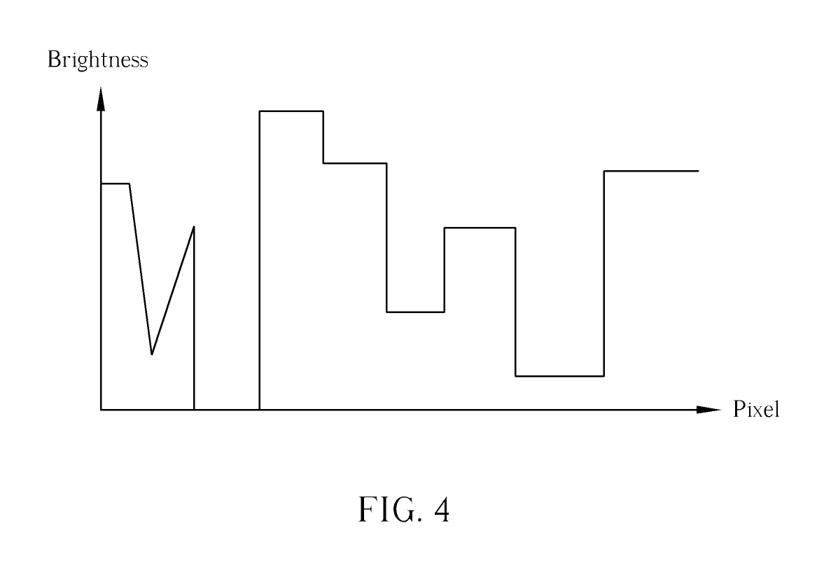

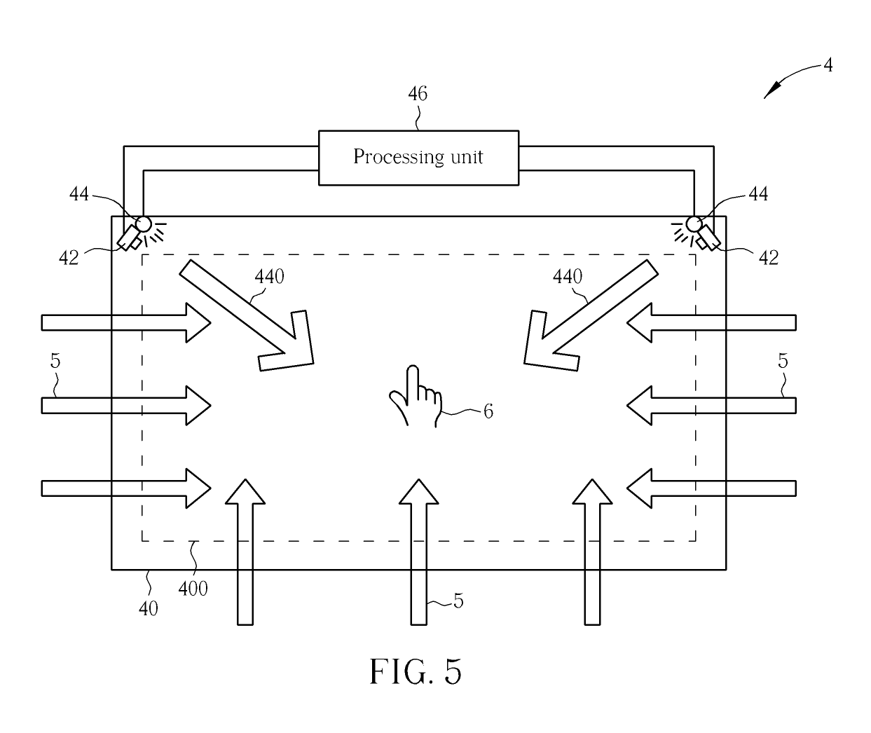

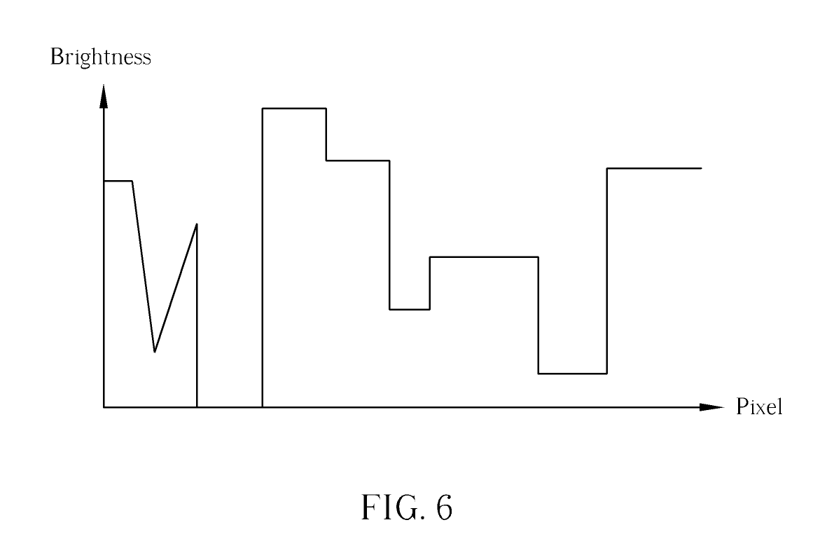

Referring to FIGS. 3 to 6, FIG. 3 is a schematic diagram illustrating a frameless optical touch device 4 according to an embodiment of the invention, FIG. 4 is a diagram illustrating brightness distribution of a first image generated by an image sensing unit 42 while there is no any touch object in a sensing region 400 shown in FIG. 3, FIG. 5 is a schematic diagram illustrating a touch object 6 in a sensing region 400 shown in FIG. 3, and FIG. 6 is a diagram illustrating brightness distribution of a second image generated by an image sensing unit 42 while there is a touch object 6 in a sensing region 400 shown in FIG. 5.

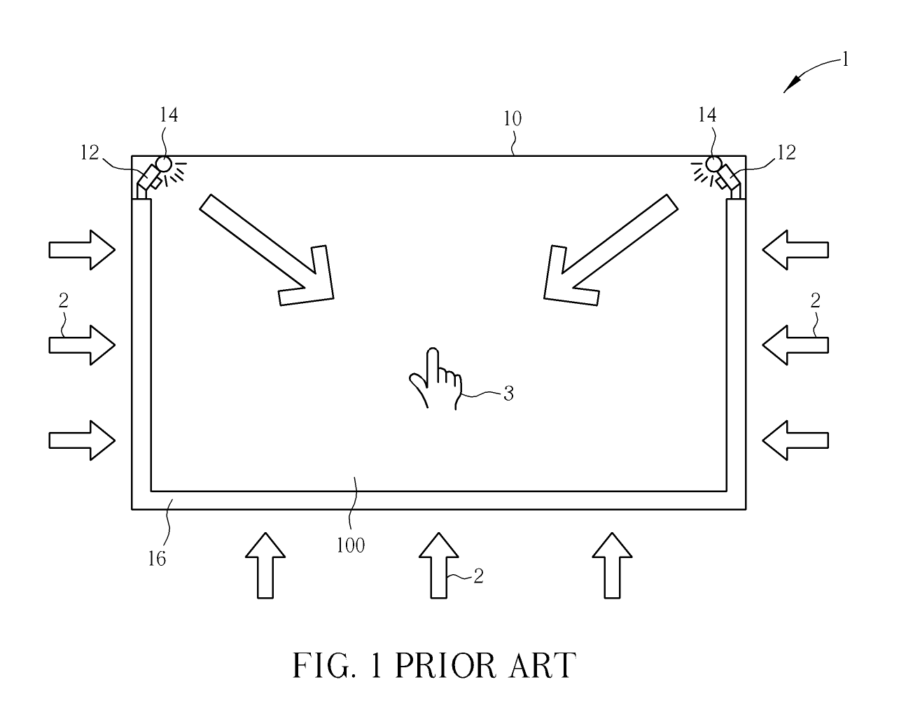

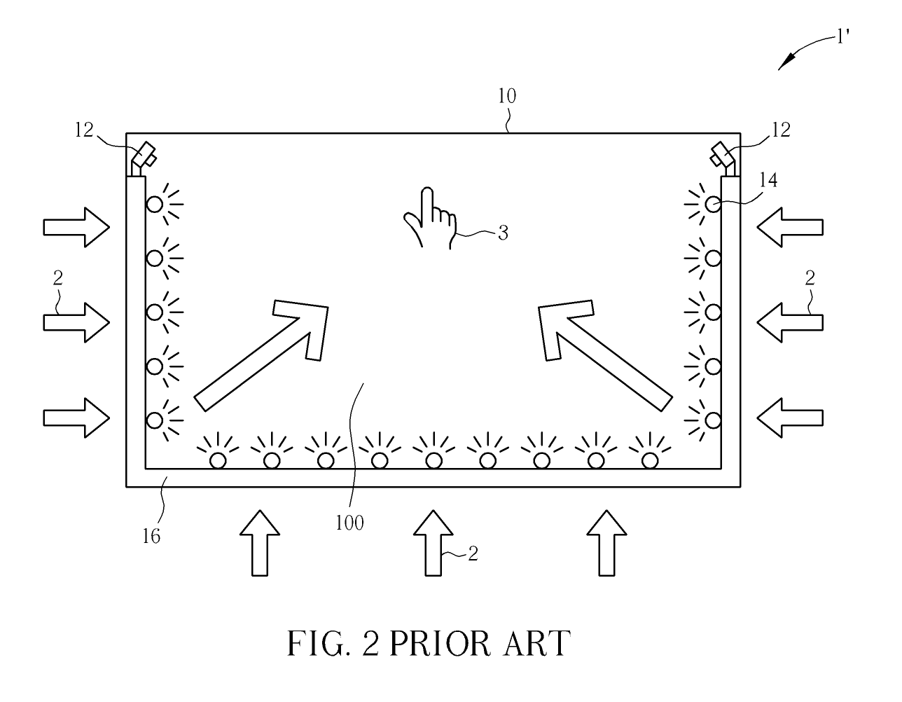

As shown in FIG. 3, the frameless optical touch device 4 comprises an indication plane 40, two image sensing units 42, two light emitting units 44 and a processing unit 46. In practical applications, the indication plane 40 maybe a touch panel for a user to perform touch function. A sensing region 400 is defined on the indication plane 40. There is no any frame disposed on a periphery of the indication plane 40. That is to say, the periphery of the indication plane 40 of the frameless optical touch device 4 of the invention does not have the frame 16 of the prior art, which is shown in FIGS. 1 and 2 and used for isolating environmental light. Accordingly, a first light 5 (i.e. environmental light) from an external environment is able to enter the sensing region 400 through the periphery of the indication plane 40. The two image sensing units 42 are disposed at opposite corners of the indication plane 40 respectively. The two light emitting units 44 are disposed adjacent to the two image sensing units 42 respectively and used for emitting a second light 440 to the sensing region 400. The processing unit 46 is electrically connected to the image sensing units 42 and the light emitting units 44 . The processing unit 46 is used for processing images sensed by the image sensing units 42 and controls the light emitting units 44 to emit light.

Since there is no any frame disposed on the periphery of the indication 40 of the frameless optical touch device of the invention, the first light 5 from the external environment, where the indication plane 40 is located at, and the second light 440 from the light emitting units 44 will mix with each other within the sensing region 400.

In practical applications, the image sensing unit 42 may be, but not limited to, a charge-coupled device (CCD) sensor or a complementary metal-oxide semiconductor (CMOS) sensor, the light emitting unit 44 may be, but not limited to, a light emitting diode, and the processing unit 46 may be a processor or a controller with data calculating/processing function.

As shown in FIG. 3, when there is no any touch object in the sensing region 400, the image sensing unit 42 senses the first light 5 and the second light 440 within the sensing region 400 so as to generate a first image, wherein brightness distribution of the first image is shown in FIG. 4. As shown in FIG. 5, when a touch object 6 is in the sensing region 400, the image sensing unit 42 senses the first light 5 and the second light 440 within the sensing region 400 so as to generate a second image, wherein brightness distribution of the second image is shown in FIG. 6. Afterward, the processing unit 46 compares brightness of the first image with brightness of the second image so as to obtain a position blocked by the touch object 6 in the second image. The touch object 6 may be, but not limited to, a finger or a stylus.

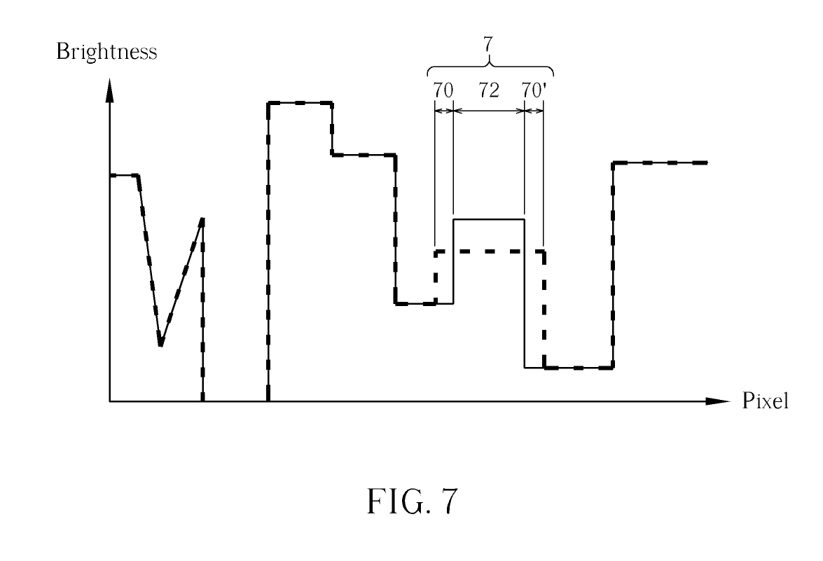

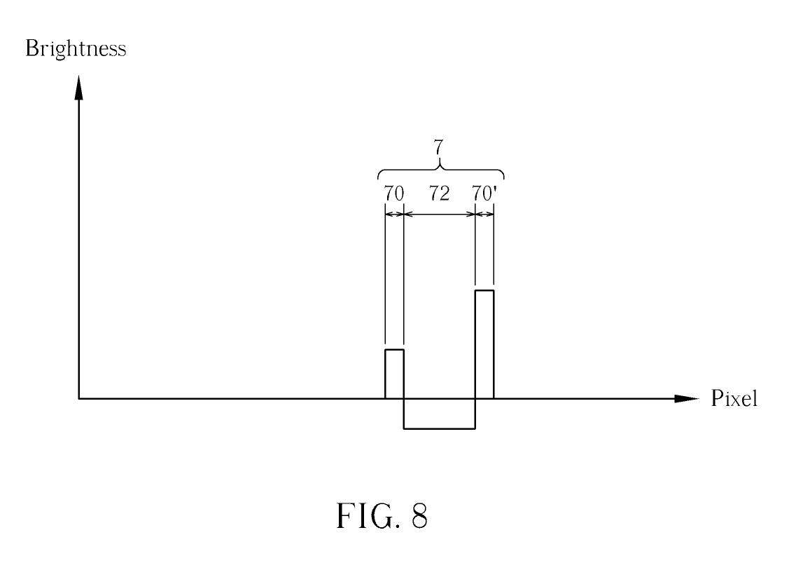

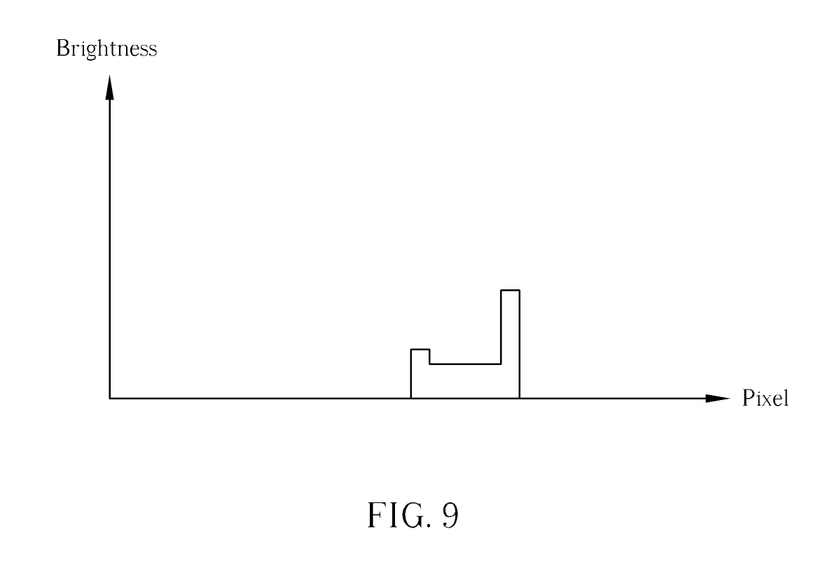

Referring to FIGS. 7 to 9, FIG. 7 is a diagram illustrating brightness variation between brightness distribution of the first image (solid line) shown in FIG. 4 and brightness distribution of the second image (broken line) shown in FIG. 6, wherein a brightness variation area 7 represents the position blocked by the touch object 6; FIG. 8 is a diagram illustrating brightness distribution of the brightness variation area 7 shown in FIG. 7; and FIG. 9 is a diagram illustrating brightness distribution of the brightness variation area 7 after being transformed into absolute values.

As shown in FIG. 7, the position blocked by the touch object 6 in the second image is corresponding to a brightness variation area 7 between the first image and the second image, wherein the brightness variation area 7 comprises two bright areas 70, 70′ and one dark area 72. The bright areas 70, 70′ represent that brightness of the touch object 6 sensed by the image sensing unit 42 is higher than brightness of background. The dark area 72 represents that brightness of the touch object 6 sensed by the image sensing unit 42 is lower than brightness of background.

It should be noted that, in this embodiment, the brightness variation area 7 substantially consists of three parts including bright are 70, dark area 72 and bright area 70′ from left to right. However, if whole brightness of the touch object 6 sensed by the image sensing unit 42 is higher than brightness of background, the brightness variation area will substantially consist of only one bright area. On the other hand, if whole brightness of the touch object 6 sensed by the image sensing unit 42 is lower than brightness of background, the brightness variation area will substantially consist of only one dark area.

Afterward, the processing unit 46 compares brightness of the first image with brightness of the second image by image processing technology so as to obtain brightness distribution shown in FIG. 8. In this embodiment, the processing unit 46 may subtract brightness of the first image from brightness of the second image so as to obtain the brightness variation area 7. Regarding the left bright area 70, brightness of the second image is higher than brightness of the first image (as shown in FIG. 7), so a positive value is obtained after subtracting brightness of the first image from brightness of the second image (as shown in FIG. 8). Regarding the central dark area 72, brightness of the second image is lower than brightness of the first image (as shown in FIG. 7), so a negative value is obtained after subtracting brightness of the first image from brightness of the second image (as shown in FIG. 8). Regarding the right bright area 70′, brightness of the second image is higher than brightness of the first image (as shown in FIG. 7), so a positive value is obtained after subtracting brightness of the first image from brightness of the second image (as shown in FIG. 8).

It should be noted that, in this embodiment, the processing unit 46 may also subtract brightness of the second image from brightness of the first image so as to obtain brightness variation area. At this time, positive/negative of the brightness variation area will be opposite to the brightness distribution shown in FIG. 8. Furthermore, once a difference between brightness of the first image and brightness of the second image is smaller than a predetermined error range, the processing unit 46 determines that brightness of the second image is identical to brightness of the first image so as to prevent erroneous determination due to slight variation of environmental light.

Afterward, the processing unit 46 transforms a difference between brightness of the first image and brightness of the second image within each part of the brightness variation area 7 into an absolute value so as to obtain the brightness distribution shown in FIG. 9. In this embodiment, the processing unit 46 can determine the position blocked by the touch object 6 in the second image according to the brightness distribution shown in FIG. 9.

It should be noted that once the absolute value of brightness within a sub-area of the brightness variation area 7 is equal to zero and a scale of the sub-area is smaller than a predetermined error range (e.g. a range of ten pixels) , the processing unit 46 determines that the brightness variation area 7 is a continuous brightness variation range. At this time, the processing unit 46 takes this continuous brightness variation area as one single touch operation. Furthermore, in another embodiment, once a scale of the brightness variation area 7 is smaller than a predetermined error range (e.g. a range of thirty pixels), the processing unit 46 determines that the brightness variation area 7 is a continuous brightness variation range. At this time, the processing unit 46 takes this continuous brightness variation area as one single touch operation. The aforesaid manners are used to prevent erroneous determination if partial brightness of the position blocked by the touch object 6 cannot be distinguished from brightness of background.

Finally, the processing unit 46 calculates a coordinate of the position indicated by the touch object 6 on the indication plane 40 by triangulation method according to the position blocked by the touch object 6 in the second image.

In this embodiment, after the frameless optical touch device 4 is powered, the processing unit 46 controls the image sensing unit 42 to sense the first light 5 and the second light 440 within the sensing region 400 in advance so as to generate a background image for follow-up image comparison.

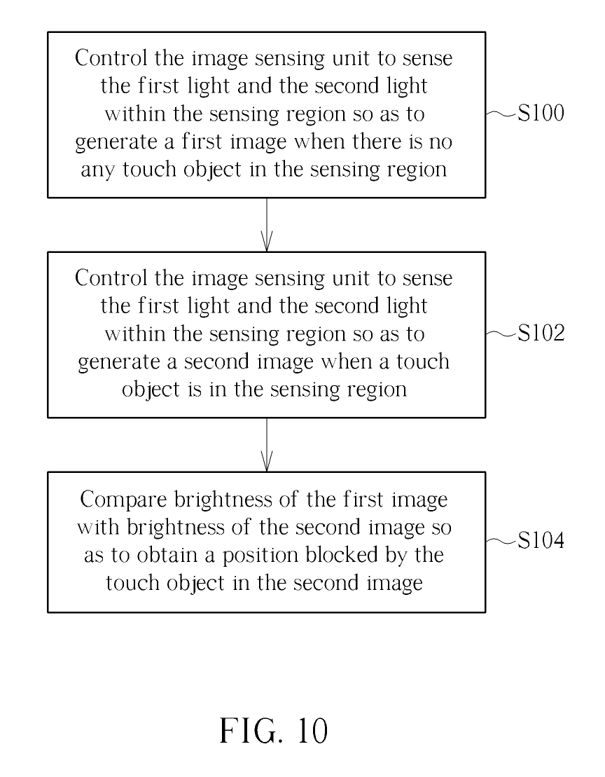

Referring to FIG. 10, FIG. 10 is a flowchart illustrating an image processing method for the frameless optical touch device 4 according to an embodiment of the invention. As shown in FIG. 10, first of all, step S100 is performed to control the image sensing unit 42 to sense the first light 5 and the second light 440 within the sensing region 400 so as to generate a first image when there is no any touch object in the sensing region 400. For example, after the frameless optical touch device 4 is powered, the processing unit 46 controls the image sensing unit 42 to sense the first light 5 and the second light 440 within the sensing region 400 in advance so as to generate a background image. It should be noted that step S100 is not limited to be performed while the frameless optical touch device 4 is powered.

Afterward, step S102 is performed to control the image sensing unit 42 to sense the first light 5 and the second light 440 within the sensing region 400 so as to generate a second image when a touch object 6 is in the sensing region 400. The second image generated in step S102 is different from the first image generated in step S100 since the touch object 6 has been in the sensing region 400.

Finally, step S104 is performed to compare brightness of the first image with brightness of the second image so as to obtain a position blocked by the touch object 6 in the second image. It should be noted that how to compare brightness of the first image with brightness of the second image in step S104 has been mentioned in the above and thus the details will not be repeated herein.

Compared with the prior art, there is no any frame disposed on the periphery of the indication plane of the frameless optical touch device of the invention such that the first light from an external environment is able to enter the sensing region through the periphery of the indication plane. Before and after the touch object is in the sensing region, the image sensing unit senses both the first light from the external environment and the second light from the light emitting unit so as to generate the first image and the second image. Afterward, the processing unit compares brightness of the first image with brightness of the second image by image processing technology so as to obtain the position blocked by the touch object in the second image. Since the frameless optical touch device of the invention does not have the frame disposed on the periphery of the indication plane of the prior art, the invention can enhance assembly efficiency and reduce manufacture cost of the frameless optical touch device effectively.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A frameless optical touch device comprising:
an indication plane, a sensing region being defined on the indication plane, there being no any frame disposed on a periphery of the indication plane such that a first light from an external environment is able to enter the sensing region through the periphery of the indication plane;
an image sensing unit disposed at a corner of the indication plane;
a light emitting unit disposed adjacent to the image sensing unit and used for emitting a second light to the sensing region; and
a processing unit electrically connected to the image sensing unit and the light emitting unit;
wherein when there is no any touch object in the sensing region, the image sensing unit senses the first light and the second light within the sensing region so as to generate a first image, when a touch object is in the sensing region, the image sensing unit senses the first light and the second light within the sensing region so as to generate a second image, the processing unit compares brightness of the first image with brightness of the second image so as to obtain a position blocked by the touch object in the second image.

2. The frameless optical touch device of claim 1, wherein the position blocked by the touch object in the second image is corresponding to a brightness variation area between the first image and the second image.

3. The frameless optical touch device of claim 2, wherein the processing unit subtracts brightness of the first image from brightness of the second image so as to obtain the brightness variation area.

4. The frameless optical touch device of claim 3, wherein once a difference between brightness of the first image and brightness of the second image is smaller than a predetermined error range, the processing unit determines that brightness of the second image is identical to brightness of the first image.

5. The frameless optical touch device of claim 2, wherein the processing unit transforms a difference between brightness of the first image and brightness of the second image within the brightness variation area into an absolute value so as to determine the position blocked by the touch object in the second image.

6. The frameless optical touch device of claim 5, wherein once a difference between brightness of the first image and brightness of the second image within a sub-area of the brightness variation area is equal to zero and a scale of the sub-area is smaller than a predetermined error range, the processing unit determines that the brightness variation area is a continuous brightness variation range.

7. The frameless optical touch device of claim 5, wherein once a scale of the brightness variation area is smaller than a predetermined error range, the processing unit determines that the brightness variation area is a continuous brightness variation range.

8. The frameless optical touch device of claim 2, wherein the brightness variation area is one selected from a group consisting of: a dark area, a bright area, and a combination thereof.

9. The frameless optical touch device of claim 2, wherein the brightness variation area comprises at least one dark area and at least one bright area.

10. The frameless optical touch device of claim 1, wherein after the frameless optical touch device is powered, the processing unit controls the image sensing unit to sense the first light and the second light within the sensing region in advance.

11. An image processing method for a frameless optical touch device, the frameless optical touch device comprising an indication plane, an image sensing unit and alight emitting unit, a sensing region being defined on the indication plane, there being no any frame disposed on a periphery of the indication plane such that a first light from an external environment is able to enter the sensing region through the periphery of the indication plane, the image sensing unit being disposed at a corner of the indication plane, the light emitting unit being disposed adjacent to the image sensing unit and used for emitting a second light to the sensing region, the image processing method comprising:
when there is no any touch object in the sensing region, controlling the image sensing unit to sense the first light and the second light within the sensing region so as to generate a first image;
when a touch object is in the sensing region, controlling the image sensing unit to sense the first light and the second light within the sensing region so as to generate a second image; and
comparing brightness of the first image with brightness of the second image so as to obtain a position blocked by the touch object in the second image.

12. The frameless optical touch device of claim 11, wherein the position blocked by the touch object in the second image is corresponding to a brightness variation area between the first image and the second image.

13. The frameless optical touch device of claim 12, further comprising:
subtracting brightness of the first image from brightness of the second image so as to obtain the brightness variation area.

14. The frameless optical touch device of claim 13, further comprising:
once a difference between brightness of the first image and brightness of the second image is smaller than a predetermined error range, determining that brightness of the second image is identical to brightness of the first image.

15. The frameless optical touch device of claim 12, further comprising:
transforming a difference between brightness of the first image and brightness of the second image within the brightness variation area into an absolute value so as to determine the position blocked by the touch object in the second image.

16. The frameless optical touch device of claim 15, further comprising:
once a difference between brightness of the first image and brightness of the second image within a sub-area of the brightness variation area is equal to zero and a scale of the sub-area is smaller than a predetermined error range, determining that the brightness variation area is a continuous brightness variation range.

17. The frameless optical touch device of claim 15, further comprising:
once a scale of the brightness variation area is smaller than a predetermined error range, determining that the brightness variation area is a continuous brightness variation range.

18. The frameless optical touch device of claim 12, wherein the brightness variation area is one selected from a group consisting of: a dark area, a bright area, and a combination thereof.

19. The frameless optical touch device of claim 12, wherein the brightness variation area comprises at least one dark area and at least one bright area.

20. The frameless optical touch device of claim 11, further comprising:
after the frameless optical touch device is powered, controlling the image sensing unit to sense the first light and the second light within the sensing region in advance.
